(19) United States
(12) Patent Application Publication
(10) Pub. No.: US 2021/0190122 A1
(43) Pub. Date: Jun. 24, 2021

(54) Channel Fastener

(71) Applicant: Rhino Rack Australia Pty Limited, Eastern Creek, (AU)

(72) Inventors: Adam Connellan, Eastern Creek (AU); Tarek Alfakhrany, Eastern Creek (AU); Sam Whelan, Eastern Creek (AU)

(21) Appl. No.: 17/126,579

(22) Filed: Dec. 18, 2020

(30) Foreign Application Priority Data
Dec. 18, 2019 (AU) 2019904792

(51) Int. Cl. F16B 37/04; F16B 35/06

(52) U.S. Cl. CPC F16B 37/045; F16B 35/06

(57) ABSTRACT

The present invention relates to a fastener for mounting an object to structure having a C-shaped channel having a slot and flanges on either side thereof, the fastener comprising a bolt having a head sized to pass through the channel slot and a washer comprising a washer hole, the washer being configured to pivot about an axis substantially perpendicular to the shank of the bolt when the bolt extends therethrough, wherein the washer is pivotable between an insertion configuration, such that a bolt head and the washer may be inserted into the slot of the C-shaped channel and an engaging configuration, wherein the washer engages with the channel flanges, preventing withdrawal of the fastener from the channel.

### PRIORITY CLAIM

The present application claims priority from Australian provisional patent application AU 2019904792, filed on 18 Dec. 2019, the entirety of which is incorporated herein by reference.

### TECHNICAL FIELD

The present invention relates generally to the field of connections and fasteners, and more particularly to mounting systems for mounting to rails and channels.

### BACKGROUND

Mounting channels are a well-known mounting system—a channel nut within a C-shaped mounting channel allows for an object to be bolted thereto, with the channel allowing for the object's position to be changed by sliding the channel nut therealong. However the channel nut must be wider than the flanges of the mounting channel to ensure that it can urge against the flanges and be held in place. Prior art systems therefore required a means of inserting the channel nut into the channel.

Certain prior art systems utilised widened apertures spaced along a channel, the aperture permitting a channel nut to be inserted into the channel. However, this required specialized machinery to cut or otherwise shape the apertures into the channel structure. This is particularly evident when a channel is part of an extruded structure; typical extrusion processes do not easily allow for variation in an extruded product's structure along its length, necessitating additional manufacturing steps to cut or shape the apertures.

Other systems provided an open end to the channel, requiring that the channel nut be fed along the length of the channel to the desired position. This requires that a channel either have a permanently open end or, if the channel is incorporated into a structure's body, the structure must be at least partially disassemblable to enable access to the channel. This carries its own host of issues in that permanently-open channel ends provide catchment for dirt, dust and other contaminants, while routine disassembly can weaken connections between components over time.

Certain channel fasteners are adapted to be inserted into a typical channel, and typically comprise a channel nut with a ‘long’ axis and a ‘short’ axis. The channel nut is inserted into the channel with the ‘long’ axis aligned with the channel direction. Once inserted, the channel nut can be laterally rotated within the channel such that its ‘long’ axis is transverse to the channel, thus enabling the channel nut to contact with the channel flanges. However, such prior art channel nuts are often complex in design—providing points of failure—or otherwise prone to lateral over-rotation, risking loss of contact between the channel nut and the channel flanges.

There is therefore a need for a means of providing the ability to fasten an object to a point along a channel while overcoming or at least ameliorating the disadvantages of the prior art means.

### DISCLOSURE OF THE INVENTION

In a first aspect, the present invention relates to a fastener for mounting an object to structure having a C-shaped channel having a slot and flanges on either side thereof, the fastener comprising a bolt having a head sized to pass through the channel slot, and a washer comprising a washer hole, the washer being configured to pivot about an axis substantially perpendicular to the shank of the bolt when the bolt extends therethrough, wherein the washer is pivotable between an insertion configuration, such that a bolt head and the washer may be inserted into the slot of the C-shaped channel and an engaging configuration, wherein the washer engages with the channel flanges, preventing withdrawal of the fastener from the channel.

In an embodiment, the bolt head comprises a pair of cylindrical arms extending in opposite directions to one another and perpendicular to the bolt shank, and the washer comprises a channel having an arcuate cross-section extending across a portion of an underside, such that when the bolt extends through the washer, the bolt arms sit within the arcuate washer channel, and the washer is able to slidably pivot, about the arms, between the insertion and engaging configurations.

In an embodiment, the washer hole comprises at least one sloping side wall shaped to increase an angle by which the washer is able to pivot about the bolt shank.

In an embodiment, a side portion of the washer is weighted, and when the washer is resting against the bolt head and the bolt shank extends through the washer hole, the weighted side portion urges the washer to pivot towards the insertion configuration.

### DESCRIPTION OF FIGURES

Embodiments of the present invention will now be described in relation to figures, wherein:

FIG. 1A depicts a structure having a mounting channel;

FIGS. 1B a& 1C depict an embodiment of the bolt and washer;

FIGS. 2A & 2B depict an embodiment of the washer pivoting;

FIGS. 3A & 3B depict an embodiment of the fastener being inserted into a mounting channel;

FIGS. 4A-4C depict a further embodiment of the bolt and washer; and

FIG. 5 depicts a further embodiment of the washer of the present invention.

### DETAILED DESCRIPTION OF PREFERRED EMBODIMENTS

In a broad first aspect, the present invention relates to a fastener for mounting an object to a structure having a typical C-shaped channel. The fastener comprises a bolt and a pivotable washer, wherein the washer is able to pivot between a configuration enabling the bolt and washer to be inserted into the channel (the ‘insertion configuration’) and a configuration wherein the washer engages with the channel, preventing withdrawal (the ‘engaging configuration).

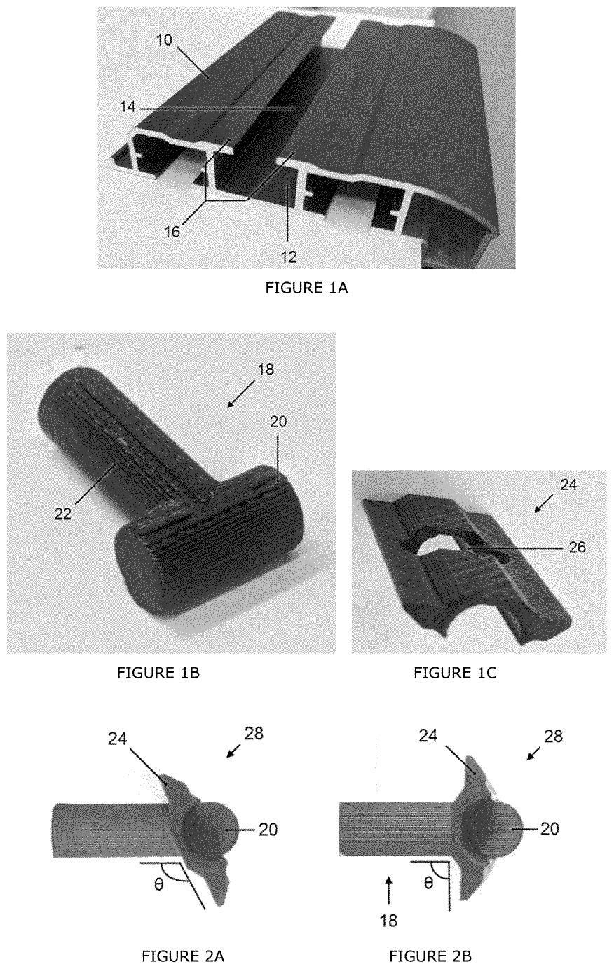

FIG. 1A depicts a cross-section of a structure 10 with C-shaped channel 12, being a channel shaped such that the slot 14 that opens into the channel is bordered by lateral flanges 16. FIGS. 1B and 1C depict an embodiment of components to form a fastener for mounting an object to the structure 10 by engaging with the channel 12. FIG. 1B in particular depicts an embodiment of a bolt 18, having a bolt head 20 that is sized to fit through the channel slot 14 and a bolt shank 22 that extends from the bolt head 20. In some embodiments, the bolt shank 22 may be threaded for at least a portion of its length. FIG. 1C depicts an embodiment of the pivotable washer 24, having hole 26 through which the bolt shank 22 extends.

FIGS. 2A and 2B depict the washer 24 in connection with the bolt 18 to form an embodiment of the fastener 28. As depicted in FIGS. 2A and 2B, the washer 24 is configured to pivotable about an axis substantially perpendicular to the bolt shank 22. FIG. 2A depicts an embodiment of the fastener 28 in an ‘insertion configuration’, wherein the washer 24 is pivoted about an axis substantially perpendicular to the bolt shank 22 such that the washer 24 is at an angle away from normal to the bolt shank 22. This may be contrasted against FIG. 2B, which depicts the same embodiment of the fastener 28 in an ‘engagement configuration’, wherein the washer 24 is essentially perpendicular to the bolt shank 22. The decreased longitudinal profile of the fastener 28 (the cross-sectional area across an axis through the bolt shank 22) and the increased angle θ of the ‘insertion configuration’ may enable the fastener 28 to be inserted into a channel slot 14.

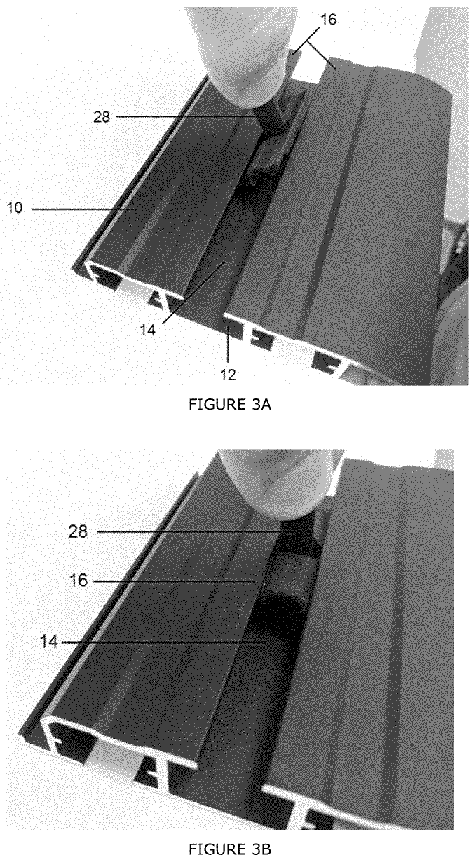

FIG. 3A depicts an embodiment of the fastener 28 in the ‘insertion configuration’ being inserted into the slot 14 of the channel 12. As depicted therein, the increased angle θ allows for at least the present embodiment of the fastener to be inserted into the slot 14. FIG. 3B alternatively depicts the inserted fastener in the ‘engagement configuration’, such that the washer 24 is essentially normal to the bolt shank 22 such that it engages against the flanges 16, preventing withdrawal of the fastener.

As depicted in FIG. 3A, insertion of the fastener into channel slot 14 requires that the fastener is angled slightly. As the skilled person may appreciate, the allowable change in angle θ for a particular embodiment of the present invention depends upon the strength required within the washer 24. Heavy-duty applications may require a stronger washer 24 that is, in turn, less able to pivot about the bolt shank 22 to alter the angle θ. Other applications, wherein strain upon the washer 24 is lower, may allow for a greater change in angle θ. In some embodiments, the change in angle θ may be enough that the ‘longitudinal profile’ is decreased to enable the fastener to be inserted into the slot 14 without angling thereof.

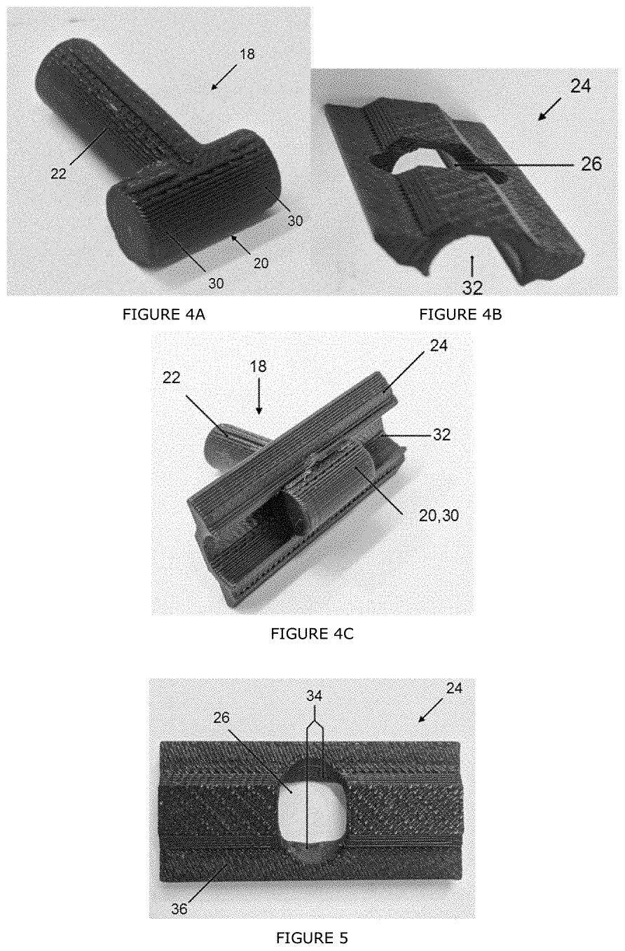

In an embodiment of the present invention and with reference to FIGS. 4A-C, the bolt head 20 may comprise a pair of cylindrical arms 30 extending in opposite directions to one another and perpendicular to the bolt shank 22. The washer 24 may comprise an arcuate channel 32 on an underside thereof, the arcuate channel 32 arranged to intersect with the hole 26. In use, the arcuate channel 32 of the washer is arranged such that the bolt arms 30 sit at least partially within the arcuate channel 32. The arcuate channel 32 may enable the washer 24 to pivot about the bolt 18 by laterally sliding across the surface of the arms 30. Altering the depth of the arcuate channel 32, in combination with a width of the washer hole 26, may alter the amount that angle θ changes away from perpendicular to the bolt shank 22 upon shifting from the engagement configuration to the insertion configuration.

With reference to FIG. 5, in an embodiment of the present invention, the washer hole 26 may comprise one or more sloping side walls 34 positioned such that the opening of the hole 26 on one surface of the washer 24 is wider than the opening of the hole 26 on the opposing surface. In at least the present embodiment of the present invention, the sloping side walls 34 may provide greater freedom of movement to the bolt 18 upon pivoting, thereby increasing the amount that angle θ changes away from perpendicular to the bolt shank 22 upon shifting from the engagement configuration to the insertion configuration.

With further reference to FIG. 5, in an embodiment of the present invention, one side portion of the washer 24 may be a weighted side portion 36. In such an embodiment, use of a weighted side portion 36 may urge the washer 24 to naturally pivot about the bolt shank 22 into an insertion configuration. The weighted side portion 36 may therefore aid in insertion of the fastener 28 into the channel 12.

While the invention has been described with reference to preferred embodiments above, it will be appreciated by those skilled in the art that it is not limited to those embodiments, but may be embodied in many other forms, variations and modifications other than those specifically described. The invention includes all such variation and modifications. The invention also includes all of the steps, features, components and/or devices referred to or indicated in the specification, individually or collectively and any and all combinations or any two or more of the steps or features.

In this specification, unless the context clearly indicates otherwise, the word “comprising” is not intended to have the exclusive meaning of the word such as “consisting only of”, but rather has the non-exclusive meaning, in the sense of “including at least”. The same applies, with corresponding grammatical changes, to other forms of the word such as “comprise”, etc.

Other definitions for selected terms used herein may be found within the detailed description of the invention and apply throughout. Unless otherwise defined, all other scientific and technical terms used herein have the same meaning as commonly understood to one of ordinary skill in the art to which the invention belongs.

Any promises made in the present document should be understood to relate to some embodiments of the invention, and are not intended to be promises made about the invention in all embodiments. Where there are promises that are deemed to apply to all embodiments of the invention, the applicant/patentee reserves the right to later delete them from the description and they do not rely on these promises for the acceptance or subsequent grant of a patent in any country.

1. A fastener for mounting an object to structure having a C-shaped channel, the C-shaped channel having a slot and flanges on either side thereof, the fastener comprising:
a bolt having a head sized to pass through the channel slot; and
a washer comprising a washer hole, the washer being configured to pivot about an axis substantially perpendicular to a shank of the bolt when the bolt extends therethrough;
wherein the washer is pivotable between:
an insertion configuration, such that a bolt head and the washer may be inserted into the slot of the C-shaped channel; and
an engaging configuration, wherein the washer engages with the channel flanges, preventing withdrawal of the fastener from the channel.

2. The fastener of claim 1, wherein the bolt head comprises a pair of cylindrical arms extending in opposite directions to one another and perpendicular to the bolt shank; and
the washer comprises a channel having an arcuate cross-section extending across a portion of an underside;
further wherein, when the bolt extends through the washer, the bolt arms sit within the arcuate washer channel; and
the washer is able to slidably pivot, about the arms, between the insertion and engaging configurations.

3. The fastener of claim 1, wherein the washer hole comprises at least one sloping side wall shaped to increase an angle by which the washer is able to pivot about the bolt shank.

4. The fastener of claim 1, wherein a side portion of the washer is weighted; and
when the washer is resting against the bolt head and the bolt shank extends through the washer hole, the weighted side portion urges the washer to pivot towards the insertion configuration.
